(19) United States
(12) Patent Application Publication
(10) Pub. No.: US 2025/0377653 A1
(43) Pub. Date: Dec. 11, 2025

(54) LOOPWATCH

(71) Applicant: Lin and Associates, Phoenix, AZ (US)

(72) Inventor: Eric F. LeBlanc, Phoenix, AZ (US)

(21) Appl. No.: 19/181,621

(22) Filed: Apr. 17, 2025

Related U.S. Application Data
(63) Continuation-in-part of application No. PCT/US23/77100, filed on Oct. 17, 2023.
(60) Provisional application No. 63/380,185, filed on Oct. 19, 2022.

(51) Int. Cl. G05B 23/02

(52) U.S. Cl. CPC G05B 23/0243

(57) ABSTRACT

Potentially-abnormal behavior of an industrial system is communicated to an operator using a computer including displaying measured parameters, evaluating whether a parameter is projected to go outside of a boundary, and warning the operator accordingly. A preceding period may be divided into multiple time periods, values of the parameter may be recalled at different times during the periods, and the values may be used to calculate whether the parameter is projected to go outside the boundary. In some embodiments, intermediate values (e.g., slopes) may be calculated for the time periods and may be combined into a combined intermediate value or combined slope used to determine whether the particular parameter is projected to go outside of the boundary within a predetermined future period of time. Changes in intermediate values may be calculated, averaged, subtracted, or divided (e.g., by a slope change factor).

### RELATED PATENT APPLICATIONS

This patent application is a continuation-in-part of, and claims priority to, International Patent Application Serial No. PCT/US23/77100 filed under the Patent Cooperation Treaty (PCT) on Oct. 17, 2023, which claims priority to U.S. Provisional Patent Application Ser. No. 63/380,185, filed Oct. 19, 2022, and has the same title, inventor, and assignee. The contents of these priority patent applications are incorporated herein by reference.

### FIELD THE INVENTION

Various embodiments relate to human machine interface (HMI) technology. Particular embodiments concern methods and software that communicate potentially abnormal behavior of an industrial system to an operator of the system. Certain embodiments concern evaluating whether a parameter is projected to go outside of a boundary within a future period of time, warning an operator when a parameter is projected to go outside the boundary, or both.

### BACKGROUND OF THE INVENTION

In normal operation of an HMI technology, operators are consistently looking for any abnormal or variable behavior in the process. In many complex industrial processes, this is a very time-consuming task, and is almost an impossibility without the aid from a tool to enable early detection in normal operations. Operators will typically scan the many (e.g., numerical) values on their screen(s) to get an idea of what is going on or perhaps what is about to happen in their process. In many cases, however, there are just too many variables to really make an assessment.

In the past, operators watched control boards that displayed (e.g., real-time) values of various parameters of the industrial system. Control panels have also been used with alarm lights that illuminated when alarm levels were reached. In some instances, colored lights were used to indicate alarm conditions. More recently, one or more computer screens have been used to display values of parameters to operators. Various graphics have been used to display information on computer screens, including displaying numerical values and displaying visual representations of gauges. In addition, computerized methods of communicating potentially abnormal behavior of an industrial system to an operator of the industrial system have been used. Further, such methods have included (e.g., using a computer), simultaneously displaying to the operator of the industrial system multiple different measured parameters of the industrial system. Such methods have also included, for instance, for a particular parameter, evaluating whether the parameter is projected to go outside of a boundary for the parameter within a predetermined future period of time. Even further, such methods have included recalling values of the parameter, for instance, at different times during the preceding time period, and using multiple values from the preceding time period to calculate whether the parameter is projected to go outside of the boundary within the predetermined future period of time. Still further, such methods have included, for example, using the computer, providing a warning to the operator when the particular parameter is projected to go outside of the boundary within the predetermined future period of time.

Room for improvement exits, however, in the way such methods evaluate whether the parameter is projected to go outside of the boundary within the predetermined future period of time. Room for improvement exists, for example, in the accuracy, efficiency, or reliability of such projections, or a combination thereof, for instance, particularly where change of the parameter over time is a non-linear function. Needs and/or potential for benefit exist for computer tools that project and communicate information about the operation of industrial systems to the operator more efficiently and accurately. Room for improvement exists over the prior art in these and other areas that may be apparent to a person of skill in the art having studied this document.

### SUMMARY OF PARTICULAR EMBODIMENTS OF THE INVENTION

This invention provides, among other things, computerized methods of projecting and/or communicating behavior of an industrial system to an operator. Various embodiments identify and communicate potentially abnormal behavior of the system to the operator. Other embodiments include computer systems, computer programs, and computer-readable storage media that contain computer-readable instructions that communicate similar information. Many embodiments provide, as objects or benefits, computer tools that, in whole or in part, communicate information about the operation of industrial systems to the operator more efficiently, more accurately, or both. Certain embodiments include, for example, using a computer, simultaneously displaying to the operator of the industrial system multiple different measured parameters of the industrial system. Further, various embodiments include, for instance, using the computer, for a particular parameter (e.g., of the multiple different measured parameters of the industrial system), evaluating whether the particular parameter is projected to go outside of a boundary for the particular parameter within a predetermined future period of time. Still further, a number of embodiments include (e.g., using the computer), providing a warning to the operator of the industrial system when the particular parameter is projected to go outside of the boundary for the particular parameter within the predetermined future period of time. Further still, in various embodiments, the evaluating whether the particular parameter is projected to go outside of the boundary for the particular parameter within the predetermined future period of time includes (e.g., using the computer), dividing a preceding period of time, for example, into multiple time periods. Even further, some embodiments include (e.g., using the computer), for instance, for each time period of the multiple time periods, recalling multiple values of the particular parameter, for example, at multiple different times during the time period. Even further still, various embodiments include (e.g., using the computer), using the multiple values from each time period of the multiple time periods to calculate whether the particular parameter is projected to go outside of the boundary for the particular parameter within the predetermined future period of time. In many embodiments, computer tools are provided that project and communicate information about the operation of industrial systems to the operator more efficiently, more accurately, or both. Further, various embodiments include or provide for correcting potentially abnormal behavior of the system.

Specific embodiments include, for example, various computerized methods of communicating potentially abnormal behavior of an industrial system to an operator of the industrial system. In a number of embodiments, for example, the method includes (e.g., using a computer, for example, simultaneously) displaying to the operator of the industrial system multiple different measured parameters of the industrial system. Further, in various embodiments, for instance, for a particular parameter of the multiple different measured parameters of the industrial system, the methods includes evaluating whether the particular parameter is projected to go outside of a boundary for the particular parameter within a predetermined future period of time. Still further, in a number of embodiments, the method includes providing a warning to the operator of the industrial system when the particular parameter is projected to go outside of the boundary for the particular parameter within the predetermined future period of time. Even further, in various embodiments, the evaluating whether the particular parameter is projected to go outside of the boundary for the particular parameter within the predetermined future period of time includes dividing a preceding period of time into multiple time periods, and (e.g., for each time period of the multiple time periods) recalling multiple values of the particular parameter at multiple different times during the time period. Even further still, in a number of embodiments, the method includes using the multiple values (e.g., from each time period of the multiple time periods) to calculate whether the particular parameter is projected to go outside of the boundary for the particular parameter within the predetermined future period of time.

Further still, in some embodiments, the using of the multiple values (e.g., from each time period of the multiple time periods) to calculate whether the particular parameter is projected to go outside of the boundary for the particular parameter within the predetermined future period of time includes (e.g., using the computer): using the multiple values (e.g., from each time period of the multiple time periods) to calculate a time-period-specific intermediate value for the time period, combining each time-period-specific intermediate value (e.g., for each time period of the multiple time periods) to obtain a combined intermediate value, and using the combined intermediate value to determine whether the particular parameter is projected to go outside of the boundary for the particular parameter within the predetermined future period of time. Even further, in particular embodiments, each time-period-specific intermediate value (e.g., for each time period of the multiple time periods) includes a slope, for example, of the particular parameter, for instance, within the time period. Even further still, in certain embodiments, the combined intermediate value is a projected slope of the particular parameter with respect to time.

Moreover, in some embodiments, the combining of each time-period-specific intermediate value includes (e.g., using the computer) subtracting a first time-period-specific intermediate value for a first time period (e.g., of the multiple time periods) from a second time-period-specific intermediate value for a second time period (e.g., of the multiple time periods). Furthermore, in particular embodiments, the second time period is more recent than the first time period, the second time period and the first time period are consecutive, or both. Additionally, in certain embodiments, the combining of each time-period-specific intermediate value includes (e.g., using the computer) calculating a difference between a first time-period-specific intermediate value for a first time period (e.g., of the multiple time periods) and a second time-period-specific intermediate value for a second time period (e.g., of the multiple time periods), adding the difference to the second time-period-specific intermediate value, or both. Meanwhile, in some embodiments, the combining of each time-period-specific intermediate value includes (e.g., using the computer) multiplying by a slope change factor, for example, that has an absolute value that is less than one, or dividing by a slope change factor, for instance, that has an absolute value that is greater than one. What's more, in particular embodiments, the combining of each time-period-specific intermediate value includes (e.g., using the computer), weighting more heavily a more-recent time-period-specific intermediate value for a more-recent time period (e.g., of the multiple time periods).

In some embodiments, the evaluating of whether the particular parameter is projected to go outside of the boundary for the particular parameter within the predetermined future period of time includes (e.g., using the computer) calculating a first slope difference, for example, between a first slope for a first time period (e.g., of the multiple time periods) and a second slope for a second time period (e.g., of the multiple time periods), and calculating a second slope difference, for instance, between the second slope for the second time period (e.g., of the multiple time periods) and a third slope for a third time period (e.g., of the multiple time periods). Further, in particular embodiments, the second time period is more recent than the first time period, the third time period is more recent than the second time period, the first time period, the second time period, and the third time period are consecutive, the first slope difference and the second slope difference are used to calculate a projected slope of the particular parameter with respect to time, or a combination thereof. Still further, in certain embodiments, the method includes averaging the first slope difference and the second slope difference (e.g., to obtain an average slope difference), subtracting the average slope difference from the third slope (e.g., to obtain a projected slope), or both. Even further, some embodiments include (e.g., using the computer) multiplying or dividing the average slope difference by a slope change factor, for example, before subtracting the average slope difference from the third slope (e.g., to obtain the projected slope). In particular embodiments, the evaluating of whether the particular parameter is projected to go outside of the boundary for the particular parameter within the predetermined future period of time includes: calculating a first slope difference, for example, between a first slope for a first time period (e.g., of the multiple time periods) and a second slope for a second time period (e.g., of the multiple time periods), and calculating a second slope difference, for instance, between the second slope for the second time period (e.g., of the multiple time periods) and a third slope for a third time period (e.g., of the multiple time periods). Further, some embodiments include calculating a third slope difference, for example, between the third slope for the third time period (e.g., of the multiple time periods) and a fourth slope for a fourth time period (e.g., of the multiple time periods).

In certain embodiments, the providing of the warning to the operator includes (e.g., using the computer), providing a visual display to the operator. For example, in some embodiments, the visual display is displayed in a first manner when the particular parameter is already outside of the boundary for the particular parameter, and the visual display is displayed in a second manner when the particular parameter is projected to go outside of the boundary for the particular parameter within the predetermined future period of time. Further, in some embodiments, the visual display to the operator includes an arrow. For instance, in particular embodiments, the arrow is displayed next to a numerical display of the particular parameter. Still further, in certain embodiments, the arrow is displayed solid when the particular parameter is already outside of the boundary for the particular parameter and the arrow is displayed hollow when the particular parameter is projected to go outside of the boundary for the particular parameter within the predetermined future period of time. Even further, in some embodiments, the warning to the operator includes (e.g., using the computer), providing an audible indication to the operator.

In a number of embodiments, the evaluating of whether the particular parameter is projected to go outside of the boundary for the particular parameter within the predetermined future period of time includes calculating a coefficient of determination, for example, for the particular parameter. Further, some embodiments include using the coefficient of determination, for instance, to select which process to use for the evaluating of whether the particular parameter is projected to go outside of the boundary for the particular parameter within the predetermined future period of time. Still further, in particular embodiments, the using the multiple values (e.g., from each time period of the multiple time periods) to calculate whether the particular parameter is projected to go outside of the boundary (e.g., for the particular parameter, within the predetermined future period of time, or both) includes using linear regression, for example, to determine whether the particular parameter is projected to go outside of the boundary for the particular parameter within the predetermined future period of time. Even further, in some embodiments, the using the multiple values (e.g., from each time period of the multiple time periods) to calculate whether the particular parameter is projected to go outside of the boundary (e.g., for the particular parameter within the predetermined future period of time) includes using a first order lag function, for instance, to determine whether the particular parameter is projected to go outside of the boundary for the particular parameter (e.g., within the predetermined future period of time). Even further still, other embodiments are described herein or would be apparent to a person of ordinary skill in the art who has studied this document.

### BRIEF DESCRIPTION OF THE DRAWINGS

FIG. 1 is an example of a display (e.g., to an operator of an industrial system) that is providing a warning to the operator that a particular parameter illustrated is projected to go outside of a boundary for the particular parameter within a predetermined future period of time;

FIG. 2 is an example of a display (e.g., to an operator of an industrial system) that is providing a warning to the operator that a particular parameter illustrated has already gone outside of a boundary and is predicted to continue within the predetermined future period of time;

FIG. 3 is another example of a display (e.g., to an operator of an industrial system) that is providing a warning to the operator that a particular parameter illustrated is projected to go outside of, and in this example above, a boundary within a predetermined future period of time;

FIG. 4 is an example of a display (e.g., to an operator of an industrial system) that is providing a warning to the operator that a particular parameter illustrated is projected to go outside of, in this example below, a boundary for the parameter within the predetermined future period;

FIGS. 5 and 6 are examples of displays (e.g., to an operator of an industrial system) of a past trend period for a particular parameter of an industrial system;

FIG. 7 is a flowchart illustrating an example of a method, for instance, a computerized method of communicating potentially abnormal behavior of an industrial system to an operator of the industrial system; and

FIG. 8 is a graph that shows preceding and future periods of time where the preceding period of time is divided into four time periods and the future period of time includes an example of a prediction for a particular parameter.

The drawings provided herewith illustrate, among other things, examples of certain aspects of particular embodiments. Other embodiments may differ. Various embodiments may include aspects shown in the drawings, described in the specification (including the claims), known in the art, or a combination thereof, as examples.

### DETAILED DESCRIPTION OF EXAMPLES OF EMBODIMENTS

This patent application describes, among other things, examples of certain embodiments, and certain aspects thereof. Other embodiments may differ from the examples described in detail herein. Various embodiments are or concern HMI technology, software, for instance, that communicates behavior of an industrial system to an operator of the system, and methods associated therewith. Various embodiments include computerized systems and methods of, and computer software for, communicating behavior of an industrial system, for example, to an operator of the system.

Various embodiments are configurable applications that enable the operator, for example, to assign and monitor important process points, for instance, without needing to view an associated display. Some embodiments continuously evaluate points, provide visual indication when a process boundary is predicted to be violated, or both, as examples. In certain embodiments, this gives the operator the ability to perform multiple tasks, for example, while still monitoring key points for early indications of process violations. Further, various embodiments can assist an operator in becoming more effective, for instance, at mitigating potential process upsets and/or adhering to quality targets. In a number of embodiments, for example, operators are able to observe critical process variables, for instance, without having to build a unique graphic or group.

In a number of embodiments, operators use alarm settings, for example, as reminders to assist them in ‘watching’ key points. Further, various embodiments eliminate the dependence of using the alarm system for control, thus reducing variability and ultimately providing a more profitable mode of operation, for example. Further, certain embodiments do not require any additional display real estate. Still further, particular embodiments are a stand-alone application, for example, that can be placed on multiple screens, utilize “wasted” real estate, or both. Even further, in some embodiments, a particular monitor is displayed, for example, above a navigation menu application, on a secondary screen, or both. Further still, in some embodiments, the application evaluates the values and indicate whether they begin to deviate from historized data, for example. Even further still, various embodiments include a custom algorithm to monitor these values, and call attention to deviations by displaying for example, a small arrow, for instance, next to the value. In certain embodiments, for example, this arrow will point up or down, for instance, to indicate that the projected value will exceed the defined boundary limits. Moreover, in some embodiments, the defined boundaries are represented by (e.g., dashed) lines, are (e.g., fully) customizable, or both, for example. Furthermore, some embodiments include additional features, for example, system alarm indication, selectable predictable time frame, draggable boundary limits, monitoring (e.g., SP, OP, or both), or a combination thereof, as examples. Further, certain embodiments are compatible with Experion TPS/C200/C300, SCADA point types, or both. Still further, various embodiments are supported on DCS platforms. Some embodiments allow an operator to monitor, for example, up to eight process points per monitor or instance, as examples. Further, in a number of embodiments, right-click functionality is available, for example, allowing for quick navigation to associated displays or detail displays of process points. Still further, in some embodiments, left clicking on a numeric value displays a trend, for example, for the time span desired. Even further, in certain embodiments, the operator can choose from, for example, 7 pre-set time frames, for instance, ranging from 5 minutes to 8 hours.

Various improvements over the prior art concern an algorithm or method, for example, for making a prediction, for instance, of whether a parameter is projected to go outside of a boundary for that parameter, for example, within a certain amount of time. Various embodiments take a fraction (e.g., ¼) of a preceding period of time and use linear regression, for example, to determine whether the process variable will go outside the boundary within the certain amount of time. But this result is not necessarily very accurate if the process variable is substantially non-linear within the (e.g., ¼) of the preceding period of time. In certain embodiments, an improvement is to divide the fraction (e.g., ¼) of the preceding period of time into (e.g., four, for instance, equal) parts & use linear regression, for example, of each of these parts. Further, some embodiments then combine or stack these linear regressions. Specific examples are described herein. Certain embodiments calculate a slope of several different windows or parts of the preceding period of time and use the slopes to make predictions using a particular algorithm or method, examples of which are described in more detail herein. In particular embodiments, for example, the method starts with a preceding time period, takes the latest fraction (e.g., ¼) of that time period, and divides that fraction up into (e.g., four, for instance, equal) parts. Still further, various embodiments calculate the slope of each part, calculate the change in slope between the parts, & then uses the (e.g., three) changes in slope, the most recent slope, or both, to predict what the approximate slope of the parameter will be going forward, for example, with respect to time. Some embodiments average the slope changes. Further, some embodiments divide by a slope change factor that may be a constant that is greater than one, for example, to moderate the predicted slope.

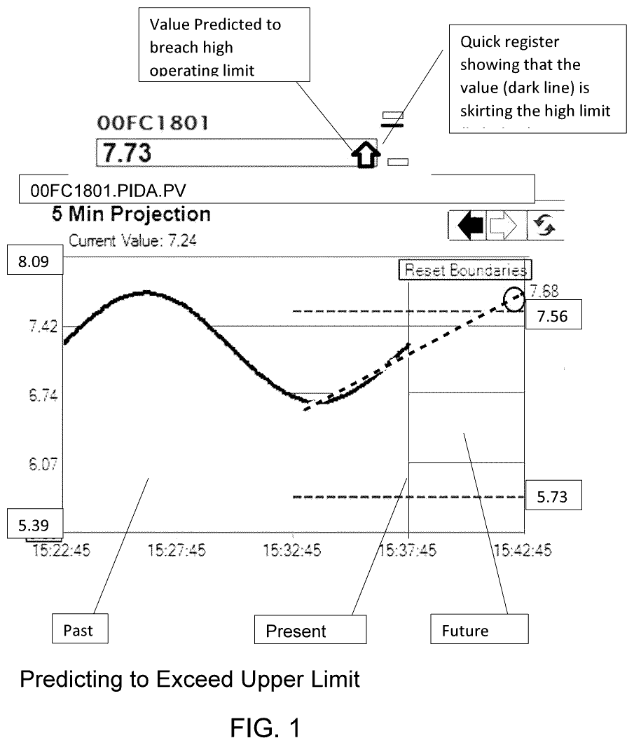

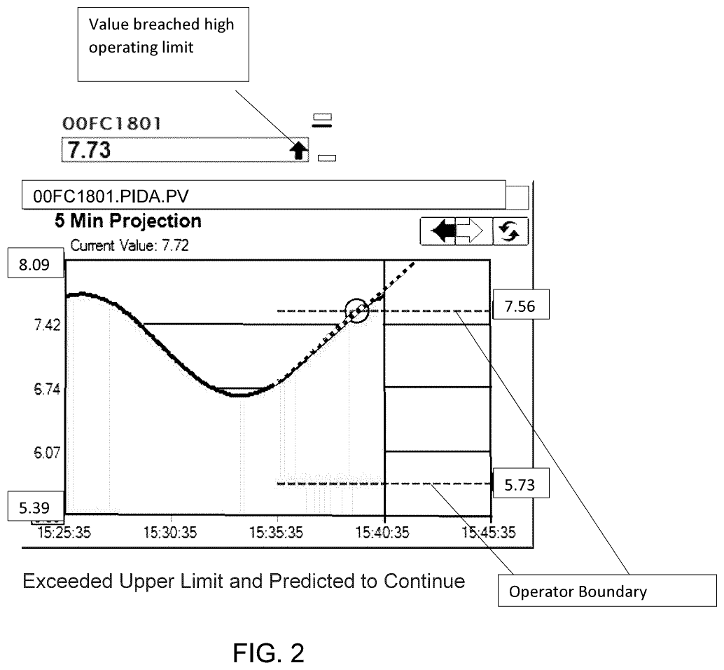

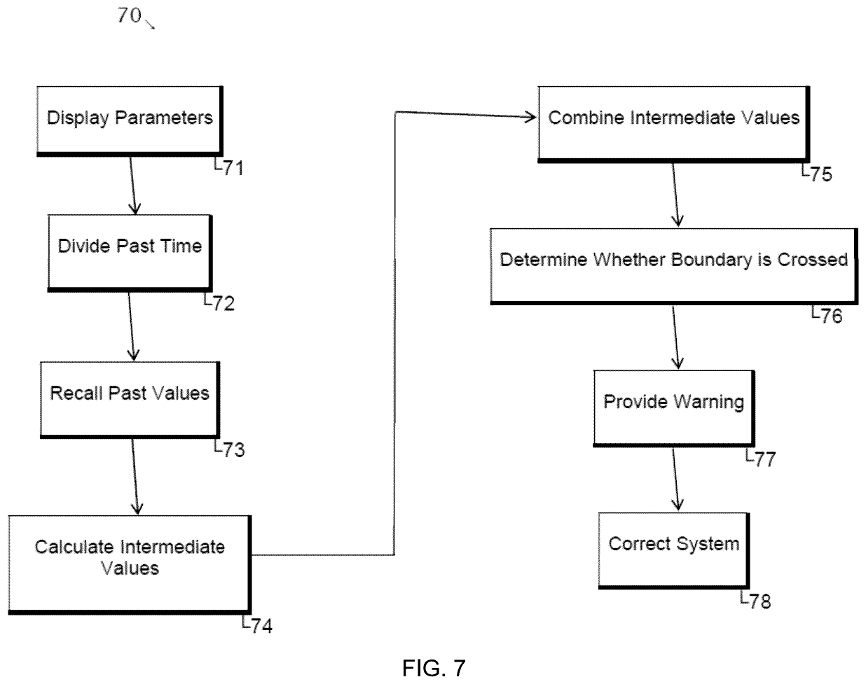

Various specific embodiments are or include a computerized method, for example, of communicating potentially abnormal behavior of an industrial system, for instance, to an operator of the industrial system. FIG. 7 illustrates an example, method 70. In a number of embodiments, for example, the method (e.g., 70) includes various acts, for example, accomplished or performed using a computer. Acts 71-77 are examples. For instance, various embodiments include (e.g., using a computer), simultaneously displaying, for example, to the operator of the industrial system, multiple different measured parameters of the industrial system. Act 71 is an example. For further illustration, in FIGS. 1 and 2, for example, the 7.73 represents a current value of a measured parameter of an industrial system. Further, various embodiments (e.g., method 70) include (e.g., using the computer), for instance, for a particular parameter of the multiple different measured parameters of the industrial system, evaluating whether the particular parameter is projected to go outside of a boundary for the particular parameter, for example, within a predetermined future period of time. In the embodiment shown in FIG. 7, for instance, acts 72-76 combined evaluate whether the particular parameter is projected to go outside the boundary within a predetermined future period of time. Moreover, the time period labeled “Future” in FIG. 1 represents an example of a predetermined future period of time. Further still, in some embodiments, a spreadsheet may perform or illustrate such an evaluation. Still further, various embodiments include (e.g., using the computer), providing a warning, for instance, to the operator of the industrial system, for example, when the particular parameter is projected to go outside of the boundary for the particular parameter, for instance, within the predetermined future period of time. In method 70, for example, act 77 provides such a warning.

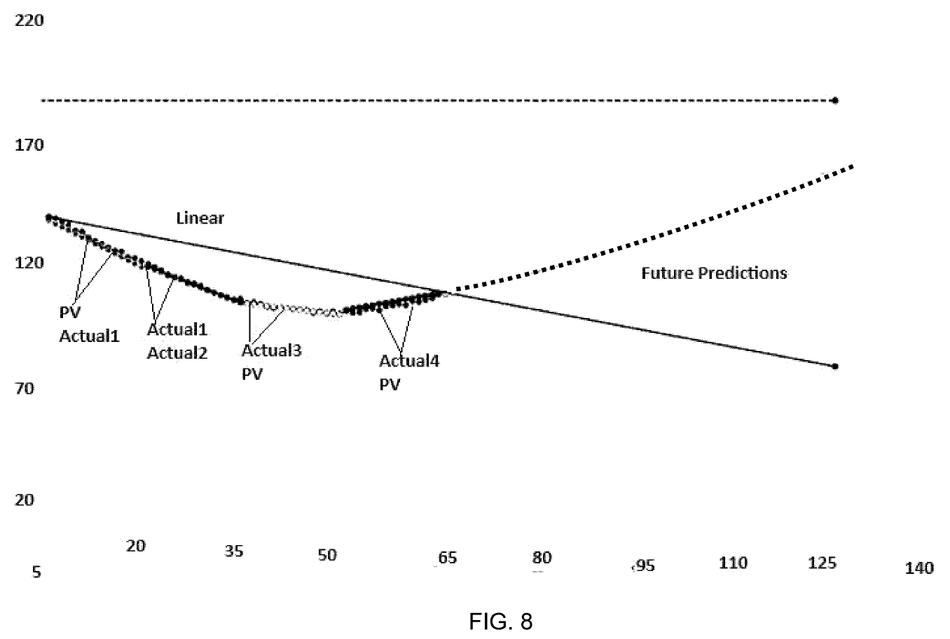

Even further, in a number of embodiments, the evaluating of whether the particular parameter is projected to go outside of the boundary (e.g., for the particular parameter) within the predetermined future period of time, for example, includes (e.g., using the computer): dividing a preceding period of time into multiple time periods (e.g., for each time period of the multiple time periods). In method 70, for instance, act 72 is an example that divides the preceding period of time into multiple time periods. Various embodiments further include recalling multiple values of the particular parameter, for instance, at multiple different times during the time period. Act 73 is an example. Further, various embodiments include using the multiple values (e.g., from each time period of the multiple time periods) to calculate whether the particular parameter is projected to go outside of the boundary (e.g., for the particular parameter), for instance, within the predetermined future period of time. In method 70 shown, act 76 is an example, as is a combination of acts, for instance, acts 74-76. For further illustration, FIG. 8 shows the preceding period of time divided (e.g., in act 72) into four time periods. Even further still, the time period labeled “Past” in FIG. 1 is an example of a preceding period of time.

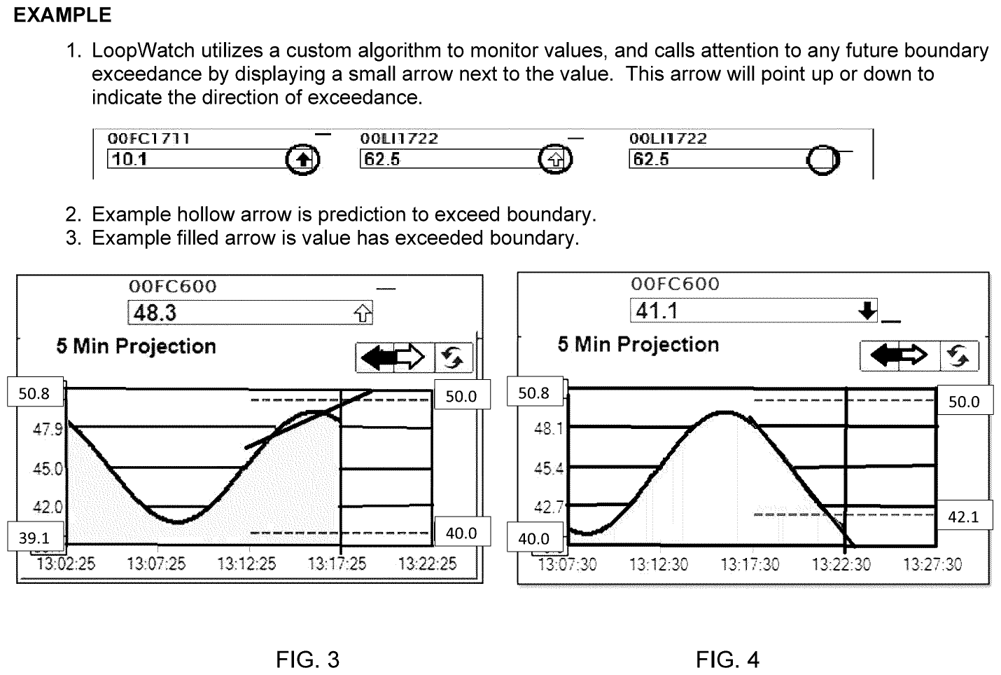

In some embodiments, for example, method 70, the using of the multiple values from each time period (e.g., of the multiple time periods) to calculate (e.g., in acts 74-76) whether the particular parameter is projected to go outside of the boundary for the particular parameter within the predetermined future period of time includes (e.g., using the computer): using the multiple values from each time period (e.g., of the multiple time periods) to calculate (e.g., in act 74) a (e.g., time-period-specific) intermediate value for the time period. Further, in the embodiment shown, method 70 includes combining (e.g., in act 75), for instance, each (e.g., time-period-specific) intermediate value, for example, for each time period (e.g., of the multiple time periods) to obtain a combined intermediate value, and using the combined intermediate value to determine (e.g., in act 76) whether the particular parameter is projected to go outside of the boundary for the particular parameter (e.g., within the predetermined future period of time). Further, in certain embodiments, each (e.g., time-period-specific) intermediate value (e.g., calculated in act 74), for instance, for each time period (e.g., of the multiple time periods) is a slope. Still further, in particular embodiments, each (e.g., time-period-specific) intermediate value (e.g., calculated in act 74), for example, for each time period (e.g., of the multiple time periods) includes a slope of the particular parameter, for example, within the time period. Even further, in some embodiments, the combined intermediate value (e.g., determined in act 75) is a slope, for example, a projected slope, for instance, of the particular parameter with respect to time. In FIGS. 1 to 4, for example, the straight sloped line in each figure that extends from the past into the future has a particular slope that represents the combined intermediate value the embodiments illustrated. Still further, in certain embodiments, the combining (e.g., in act 75) of each (e.g., time-period-specific) intermediate value (e.g., calculated in act 74) includes (e.g., using the computer) subtracting (e.g., in act 75) a first (e.g., time-period-specific) intermediate value for a first time period (e.g., of the multiple time periods) from a second (e.g., time-period-specific) intermediate value for a second time period (e.g., of the multiple time periods). Even further still, in various embodiments, the second time period is more recent than the first time period, the second time period and the first time period are consecutive, or both. In FIG. 8, for example, the four time periods are consecutive and the one on the right is most recent.

Moreover, in some embodiments, the combining (e.g., in act 75 in the embodiment shown) of each (e.g., time-period-specific) intermediate value includes (e.g., using the computer) calculating a difference between a first (e.g., time-period-specific) intermediate value for a first time period (e.g., of the multiple time periods) and a second (e.g., time-period-specific) intermediate value for a second time period (e.g., of the multiple time periods), adding the difference to the second (e.g., time-period-specific) intermediate value, or both. Further, in particular embodiments, the combining (e.g., in act 75 in method 70) of each (e.g., time-period-specific) intermediate value includes (e.g., using the computer) multiplying by a slope change factor, for example, that has an absolute value that is less than one, or dividing by a slope change factor, for instance, that has an absolute value that is greater than one. An example of a slope change factor is 4, for instance. Further still, in some embodiments, the combining (e.g., in act 75) of each (e.g., time-period-specific) intermediate value includes (e.g., using the computer) weighting differently (e.g., more heavily, with one or more coefficients or slope change factors, or both, for example) a more-recent (e.g., time-period-specific) intermediate value for a more-recent time period (e.g., of the multiple time periods). Even further, in certain embodiments, each time period (e.g., of the multiple time periods) includes a start time for the time period, an end time for the time period, or both. Still further, in some embodiments, the (e.g., time-period-specific) intermediate value for the time period is calculated (e.g., using the computer, for instance, in act 74) using values of the particular parameter at the start time for the time period, at the end time for the time period, or both. On the other hand, in some embodiments, each time period (e.g., of the multiple time periods) includes a start time for the time period and an end time for the time period, and the (e.g., time-period-specific) intermediate value for the time period is calculated (e.g., using the computer, for example, in act 74) using values of the particular parameter near the start time and near the end time, wherein “near”, in this context, means within 25 percent of the time period.

In various embodiments, the evaluating (e.g., acts 72-76 shown in FIG. 7) of whether the particular parameter is projected to go outside of the boundary for the particular parameter (e.g., within the predetermined future period of time) includes calculating a slope (e.g., in act 74), for example, for each time period (e.g., of the multiple time periods). This may be, for instance, a projected slope of the particular parameter, for example, with respect to time. Further, in a number of embodiments, the evaluating (e.g., acts 72-76) of whether the particular parameter is projected to go outside of the boundary for the particular parameter (e.g., within the predetermined future period of time) includes (e.g., using the computer) subtracting (e.g., in act 75) a first slope for a first time period (e.g., of the multiple time periods) from a second slope for a second time period (e.g., of the multiple time periods). Still further, in various embodiments, the second time period is more recent than the first time period, the second time period and the first time period are consecutive, or both. In some embodiments, the evaluating (e.g., acts 72-76 of method 70) of whether the particular parameter is projected to go outside of the boundary for the particular parameter (e.g., within the predetermined future period of time) includes (e.g., using the computer, for instance, in act 75) calculating a difference between a first slope for a first time period (e.g., of the multiple time periods) and a second slope for a second time period (e.g., of the multiple time periods). In particular embodiments, the evaluating (e.g., acts 72-76) of whether the particular parameter is projected to go outside of the boundary for the parameter (e.g., within the predetermined future period of time) includes (e.g., using the computer) adding (e.g., in act 75) the difference to the second slope or subtracting the difference from the second slope.

Further, in a number of embodiments, the evaluating (e.g., acts 72-76) of whether the particular parameter is projected to go outside of the boundary for the particular parameter (e.g., within the predetermined future period of time) includes (e.g., using the computer) calculating (e.g., in act 75) a first slope difference between a first slope for a first time period (e.g., of the multiple time periods) and a second slope for a second time period (e.g., of the multiple time periods), calculating (e.g., in act 75) a second slope difference between the second slope for the second time period (e.g., of the multiple time periods) and a third slope for a third time period (e.g., of the multiple time periods), or both. Still further, in various embodiments, the second time period is more recent than the first time period, the third time period is more recent than the second time period, or both. Further still, in a number of embodiments, the first time period, the second time period, the third time period, or a combination thereof, are consecutive. Even further, in various embodiments, the first slope difference, the second slope difference, or both, are used to calculate (e.g., in act 75) a projected slope, for example, of the particular parameter with respect to time. In particular embodiments, the method (e.g., 70) includes averaging (e.g., in act 75), for example, the first slope difference and the second slope difference, for instance, to obtain an average slope difference. Moreover, certain embodiments include subtracting (e.g., in act 75) the average slope difference from the third slope, for example, to obtain a projected slope. Furthermore, particular embodiments include (e.g., using the computer) multiplying or dividing (e.g., in act 75) the average slope difference by a slope change factor, for example, before subtracting the average slope difference from the third slope to obtain the projected slope. In various embodiments, the first time period, the second time period, the third time period, or a combination thereof, are equal in length, for instance, within 50, 25, 10, 5, or 1 percent, as examples.

Still further, in some embodiments, the evaluating (e.g., acts 72-76) of whether the particular parameter is projected to go outside of the boundary for the particular parameter (e.g., within the predetermined future period of time) includes calculating (e.g., in act 75) a first slope change or slope difference between a first slope for a first time period (e.g., of the multiple time periods) and a second slope for a second time period (e.g., of the multiple time periods), calculating (e.g., in act 75) a second slope difference between the second slope for the second time period (e.g., of the multiple time periods) and a third slope for a third time period (e.g., of the multiple time periods), and calculating (e.g., in act 75) a third slope difference between the third slope for the third time period (e.g., of the multiple time periods) and a fourth slope for a fourth time period (e.g., of the multiple time periods). Further, in particular embodiments, the first slope difference, the second slope difference, the third slope difference, or a combination thereof, are used (e.g., in act 75) to calculate a projected slope of the particular parameter with respect to time. Further still, in certain embodiments, the method (e.g., 70) includes averaging (e.g., in act 75) the first slope difference, the second slope difference, the third slope difference, or a combination thereof. Even further, in particular embodiments, the evaluating (e.g., acts 72-76) of whether the particular parameter is projected to go outside of the boundary for the particular parameter (e.g., within the predetermined future period of time) includes (e.g., using the computer) multiplying or dividing (e.g., in act 75) by a slope change factor, for example, multiplying (e.g., an average slope change) by a slope change factor having an absolute value that is less than one or dividing by a slope change factor having an absolute value that is greater than one. Even further still, in certain embodiments, the evaluating (e.g., acts 72-76) of whether the particular parameter is projected to go outside of the boundary for the particular parameter (e.g., within the predetermined future period of time) includes subtracting (e.g., in act 75) an average slope change (e.g., multiplied or divided by a slope change factor) from a slope of a most-recent time period (e.g., of the multiple time periods), for instance, to calculate (e.g., in act 75) a projected slope of the particular parameter with respect to time.

Moreover, some embodiments include weighting differently (e.g., in act 75), for example, more heavily, a slope of a more-recent time period (e.g., of the multiple time periods), weighting differently, for instance, more heavily, a slope change between more-recent time periods (e.g., of the multiple time periods), or both. For instance, in particular embodiments, weighting (e.g., in act 75) may be accomplished using different coefficients, for example, for different slopes, for instance, depending on how recently the slopes occurred. Further, in a number of embodiments, each time period (e.g., of the multiple time periods) includes a start time for the time period and an end time for the time period. Further still, in various embodiments, a slope for the time period is calculated (e.g., in act 74) using values of the particular parameter at the start time for the time period and at the end time for the time period. On the other hand, in some embodiments, the slope for the time period is calculated (e.g., in act 74) using values of the particular parameter near the start time for the time period and near the end time for the time period, where “near”, in this context, means within 25 percent of the time period, for example. Even further, various embodiments weight slopes differently in other ways (e.g., in act 75). For example, in certain embodiments, slopes from the first time period or time periods (e.g., two time periods) rather than the last time period or time periods (e.g., two time periods) are weighted more heavily (e.g., in act 75). Even further still, some embodiments use statistical behavior, for instance, as a weighting method (e.g., in act 75). For example, in particular embodiments, a (e.g., normal) bell curve is assumed. Moreover, in certain embodiments, one or more middle slopes, for instance, two middle slopes, are weighted more heavily (e.g., in act 75), for example, than the first and the last of the slopes. Various embodiments are contemplated, for example, that weight different slopes from different time periods differently (e.g., in act 75), in some embodiments, for instance, independently.

In a number of embodiments (e.g., method 70 shown in FIG. 7), the providing of the warning (e.g., in act 77) to the operator includes (e.g., using the computer) providing a visual display, for example, to the operator. Further, in various embodiments, the visual display is displayed (e.g., in act 77) in a first manner when the particular parameter is already outside of the boundary for the particular parameter, and the visual display is displayed in a second manner when the particular parameter is projected to go outside of the boundary for the particular parameter (e.g., within the predetermined future period of time). Still further, in some embodiments, the visual display to the operator includes an arrow, for example, displayed (e.g., in act 77) next to (e.g., horizontally next to) a (e.g., numerical) display of the particular parameter. Various examples of such arrows are shown, for example, in FIGS. 1-4. Even further, in some embodiments, the arrow, for example, is displayed (e.g., in act 77) oriented vertically. Examples are shown, for instance, in FIGS. 1 and 2. Further still, in particular embodiments, the arrow is displayed (e.g., in act 77) in a first manner when the particular parameter is already outside of the boundary for the particular parameter, and the arrow is displayed in a second manner when the particular parameter is projected to go outside of the boundary for the particular parameter (e.g., within the predetermined future period of time). Even further still, in certain embodiments, the arrow, for example, is displayed (e.g., in act 77) solid when the particular parameter is already outside of the boundary for the particular parameter, the arrow, for example, is displayed hollow when the particular parameter is projected to go outside of the boundary for the particular parameter (e.g., within the predetermined future period of time), or both. For example, a vertical arrow is displayed solid in FIG. 2 and a vertical arrow is displayed hollow in FIG. 1.

Even further, in various embodiments, when the particular parameter is projected to go above the boundary for the particular parameter (e.g., within the predetermined future period of time), the providing of the warning (e.g., in act 77) to the operator includes providing a directional indication (e.g., to the operator) that indicates that the particular parameter is projected to go above the boundary for the particular parameter. For instance, in particular embodiments, the directional indication includes an arrow pointing up (e.g., as shown in FIGS. 1 and 2). On the other hand, in some embodiments, when the particular parameter is projected to go below the boundary for the particular parameter (e.g., within the predetermined future period of time), the providing of the warning (e.g., to the operator) includes providing a directional indication (e.g., to the operator) that indicates that the particular parameter is projected to go below the boundary for the particular parameter. For example, in certain embodiments, the directional indication includes an arrow pointing down. FIGS. 1-4 show examples with arrows. Furthermore, in some embodiments, the providing of the warning to the operator (e.g., in act 77) includes (e.g., using the computer), providing an audible indication, for example, to the operator. Moreover, in particular embodiments, the audible indication to the operator differs, for example, depending on whether the particular parameter is projected to go above or below the boundary for the particular parameter (e.g., within the predetermined future period of time). For example, in certain embodiments, the audible indication to the operator (e.g., in act 77) is a first audible indication when the particular parameter is projected to go above the boundary for the particular parameter (e.g., within the predetermined future period of time), and the audible indication to the operator is a second audible indication when the particular parameter is projected to go below the boundary for the particular parameter (e.g., within the predetermined future period of time).

In particular embodiments, the evaluating (e.g., acts 72-76) of whether the particular parameter is projected to go outside of the boundary for the particular parameter (e.g., within the predetermined future period of time) includes calculating (e.g., in act 74 or 75) a coefficient of determination (e.g., R\hat{ }2 or R squared) for the particular parameter, for instance, for each time period of the multiple time periods or for one or multiple time periods of the multiple time periods. This may be done, for example, using one or more intermediate values of the particular parameter within the time period. These intermediate values, for example, may be between the start time for the time period and the end time for the time period. For instance, in particular embodiments, the intermediate values (e.g., calculated in act 74) may be midway between or not near either of the start time for the time period and the end time for the time period. Further, some embodiments include using the coefficient of determination, for example, to select which process, algorithm, or formula, to use (e.g., in act 75), or how many time periods to divide the preceding period of time into (e.g., in act 72), for instance, for the evaluating (e.g., acts 72-76) of whether the particular parameter is projected to go outside of the boundary for the particular parameter (e.g., within the predetermined future period of time). Still further, in some embodiments, the dividing of the preceding period of time into the multiple time periods (e.g., in act 72) includes dividing the preceding period of time into substantially equal time periods. Further still, in this context, unless indicated otherwise, “substantially”, means to within 10 percent of an average duration of the time periods. Even further, in particular embodiments, the dividing of the preceding period of time into the multiple time periods (e.g., in act 72) includes dividing the preceding period of time into equal time periods (i.e., equal in duration). Even further still, in certain embodiments, the dividing of the preceding period of time into the multiple time periods (e.g., in act 72) includes dividing the preceding period of time into: at least three time periods, at least four time periods, no more than ten time periods, no more than seven time periods, no more than five time periods, or no more than four time periods, as examples. Moreover, in some embodiments, the dividing of the preceding period of time into the multiple time periods (e.g., in act 72) includes (e.g., using the computer) dividing the preceding period of time into four time periods (i.e., specifically). FIG. 8 shows an example. Other embodiments, however, may use a different number of time periods.

Additionally, in various embodiments, the dividing of the preceding period of time into the multiple time periods (e.g., in act 72) includes dividing the preceding period of time into consecutive time periods. FIG. 8 shows an example. Further, in a number of embodiments, the multiple time periods end, for example, within a duration of one of the multiple time periods from a present time (i.e., the time when the displaying to the operator is taking place). “Present” is labeled in FIG. 1, for example. Still further, in certain embodiments, the multiple time periods end substantially at a present time. Further still, in this context, “substantially” means to within 10 percent of an average duration of the time periods, unless indicated otherwise. Even further, in certain embodiments, the multiple time periods end at the present time. Even further still, in some embodiments, the multiple values of the particular parameter at the multiple different times during the time period consist of two values of the particular parameter at two different times during the time period, for example, used to calculate (e.g., in act 76) whether the particular parameter is projected to go outside of the boundary. In other embodiments, however, more than two values of the particular parameter at different times during the time period may be used, for example, where the coefficient of determination is below a threshold. In various embodiments, the act or acts (e.g., acts 72-76 or 74-76) of using the multiple values from each time period (e.g., of the multiple time periods) to calculate whether the particular parameter is projected to go outside of the boundary for the particular parameter (e.g., within the predetermined future period of time) includes using linear regression, for instance, to determine whether the particular parameter is projected to go outside of the boundary for the particular parameter within the predetermined future period of time. Further, certain embodiments include using a lag function, for instance, a first order lag function, as another example, to determine whether the particular parameter is projected to go outside of the boundary for the particular parameter (e.g., within the predetermined future period of time). Other embodiments use lasso regression, ridge regression, least squares regression, or a combination thereof. Still other embodiments use a polynomial, for example, a second order polynomial, or a second order function. Still further, various embodiments assign a penalty to the coefficients, for example, like the slope change factor (e.g., in act 75).

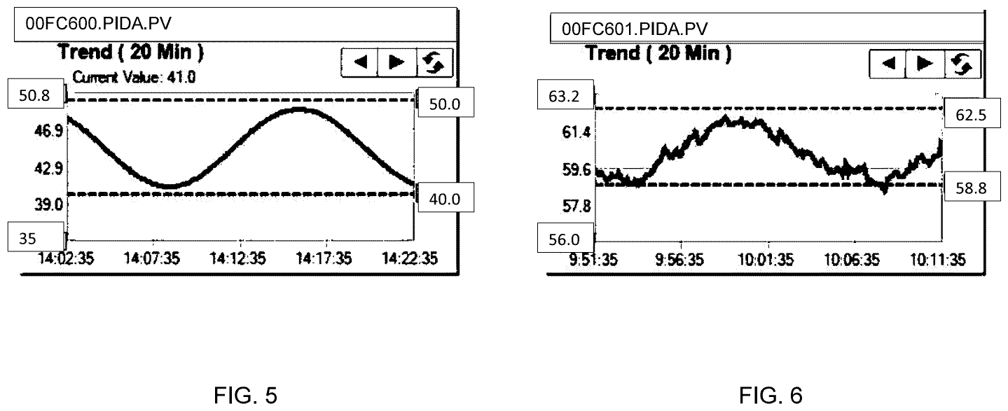

In a number of embodiments, the method (e.g., 70) includes inputting into the computer, for example, from the operator, the boundary (e.g., of act 76) for the particular parameter. Further, in various embodiments, the boundary (e.g., of act 76) for the particular parameter includes an upper boundary for the particular parameter and a lower boundary for the particular parameter. In FIGS. 1-4 the boundaries are represented by horizontal dashed lines and are labeled “Operator Boundary” in FIG. 2, for example. Still further, in some embodiments, the method (e.g., 70) involves or includes a past trend period (e.g., the “Past Time” of act 72) for the particular parameter. Further still, certain embodiments include inputting into the computer (e.g., from the operator) a duration of the past trend period (e.g., the “Past Time” of act 72) for the particular parameter. FIGS. 5 and 6, for example, show past trend periods. FIGS. 1-4 also show past trend periods, for example, labeled “Past” in FIG. 1. Even further, in various embodiments, the duration of the past trend period for the particular parameter is selectable (e.g., by the operator), for example, between 20 minutes and 2 hours, between 10 minutes and 4, or between 5 minutes and 8 hours. Even further still, in a number of embodiments, the past trend period for the particular parameter ends at a substantially present time. For example, in FIG. 1 “Present” is labeled as such. In this context, “substantially” means to within 10 percent of the past trend period, unless indicated otherwise. Moreover, in some embodiments, the multiple time periods (e.g., of act 72) (e.g., each) consist of a fraction of the past trend period (e.g., labeled “Past” in FIG. 1) for the particular parameter. For example, in various embodiments, the fraction is: less than 100 percent, less than 50 percent, no more than 25 percent, more than 0 percent, more than 5 percent, more than 10 percent, more than 15 percent, more than 20 percent, no less than 25 percent, or a combination thereof. In particular embodiments, for instance, the fraction is 25 percent.

In addition, in various embodiments, the method (e.g., 70 shown in FIG. 7) includes displaying (e.g., for the operator, for instance, in act 71 or act 77) a graph of the particular parameter over the past trend period. For instance, in particular embodiments, the graph of the particular parameter over the past trend period is displayed (e.g., using the computer) when selected (e.g., by the operator). For example, in certain embodiments, the graph of the particular parameter over the past trend period is selected (e.g., by the operator) by moving a cursor, for instance, to a visual display (e.g., to the operator) of the warning (e.g., to the operator, for instance, provided in act 77) that the particular parameter is projected to go outside of the boundary for the particular parameter (e.g., within the predetermined future period of time, for instance, as determined in act 76). Further, in various embodiments, the graph of the particular parameter over the past trend period is selected (e.g., by the operator) by clicking on a visual display (e.g., to the operator) of the warning (e.g., to the operator, for example, provided in act 77) that the particular parameter is projected to go outside of the boundary for the particular parameter (e.g., within the predetermined future period of time). For instance, in particular embodiments, the graph of the particular parameter over the past trend period is selected (e.g., by the operator) by clicking on an arrow (e.g., shown in FIGS. 1 and 2).

Still further, in a number of embodiments, the graph of the particular parameter over the past trend period (e.g., “Past” labeled in FIG. 1) includes an illustration of the boundary (e.g., labeled “Operator Boundary” in FIG. 2), for example, the graph includes at least one horizontal line depicting the boundary (e.g., two horizontal lines shown in each of FIGS. 1 and 2). Even further, in various embodiments, the graph of the particular parameter over the past trend period includes illustrations of an upper boundary for the particular parameter and a lower boundary for the particular parameter (e.g., as shown). Even further still, in a number of embodiments, the particular parameter (e.g., for which the warning is provided when appropriate, for example, in act 77) is selectable (e.g., by the operator) from (e.g., some or all of) the multiple different measured parameters (e.g., displayed in act 71).

Even further, in some embodiments, for each parameter of a plurality of parameters (e.g., of the multiple different measured parameters of the industrial system, for instance, displayed in act 71), the method (e.g., 70) includes evaluating (e.g., in acts 72-76) whether the parameter (e.g., of the plurality of parameters) is projected to go outside of the boundary for the parameter of the plurality of parameters (e.g., within the predetermined future period of time). Further, various such embodiments include providing a warning (e.g., to the operator of the industrial system, for example, in act 77) when the parameter (e.g., of the plurality of parameters) is projected to go outside of the boundary for the parameter of the plurality of parameters (e.g., within the predetermined future period of time, for instance, as determined in act 76). Still further, in various embodiments, the evaluating (e.g., acts 72-76) of whether the parameter (e.g., of the plurality of parameters) is projected to go outside of the boundary for the parameter (e.g., of the plurality of parameters), for instance, within the predetermined future period of time, includes dividing a preceding period of time into multiple time periods (e.g., in act 72), for each time period (e.g., of the multiple time periods), recalling (e.g., in act 73) multiple values of the parameter (e.g., of the plurality of parameters) at multiple different times during the time period, and using the multiple values from each time period (e.g., of the multiple time periods, for instance, in acts 72-76 or in act 76) to calculate (e.g., in acts 74-76 or in act 76) whether the parameter (e.g., of the plurality of parameters) is projected to go outside of the boundary for the parameter (e.g., of the plurality of parameters), for instance, within the predetermined future period of time. Moreover, in certain embodiments, the plurality of parameters are selectable (e.g., by the operator), for instance, from the multiple different measured parameters.

Various embodiments include using the warning (e.g., provided in act 77 of method 70 shown in FIG. 7): to mitigate a potential process upset, to adhere to a quality target, to adhere to an environmental target, or a combination thereof (e.g., for the industrial system), as examples (e.g., in act 78). Further, a number of embodiments include (e.g., using the computer, for instance, simultaneously) measuring the multiple different measured parameters of the industrial system (e.g., displayed in act 71), transmitting the multiple different measured parameters of the industrial system (e.g., to the computer), for instance, for displaying to the operator (e.g., in act 71), reading the multiple different measured parameters of the industrial system, or a combination thereof, as examples. Still further, various embodiments include: accessing (e.g., using the computer) the multiple different measured parameters of the industrial system (e.g., displayed in act 71), correcting the potentially abnormal behavior of the industrial system (e.g., in act 78), or both. In various embodiments, act 78 may be performed using the computer, by the operator, or both, as examples.

Various embodiments are or include a method (e.g., 70) of evaluating whether a particular parameter of an industrial system is projected to go outside of a boundary for the particular parameter within a predetermined future period of time. In some embodiments, the particular parameter is assumed to change over time as a sinusoidal function, for example. Further, some embodiments use least squared linear regression, for example, to calculate the slope (e.g., in act 74). Still further, certain embodiments use changes in slope to predict future change in slope, and use the predicted change in slope to then predict future values (e.g., of the parameter). Even further, some embodiments use a quadratic fit, but in particular embodiments, the quadratic term is dampened, for example, by a slope change factor. An example is to the 0.9th power. Further still, in some embodiments, an average slope is used, for instance, an average of four slopes. Even further still, in some embodiments, changes in the slopes are calculated and used, or the rate of change of slope is used. In various embodiments, for example, slope is the first derivative of the parameter value with respect to time and rate of change of slope is the second derivative of the parameter value with respect to time. Moreover, some embodiments make a prediction of a second value based on a first calculated slope and a first value. Furthermore, some embodiments make a prediction of the second value based on a second calculated slope and the first value. In addition, certain embodiments use the slope of these values or the average change, and some embodiments use differences, the slope of differences, the rate of change of cells, average slope change, the slope of slope changes, or the third derivative of the parameter value with respect to time, as examples (e.g., in act 75). Even further, some embodiments use the average change over the periods (e.g., identified in act 72), a prediction of changes, a prediction of the next slope using the rate of change of slope, which may be dampened by the slope change factor, or a combination thereof. Still further, some embodiments use the estimated slope, for example, to predict future values of the parameter. Various embodiments use an approximation of a simple quadratic fit, but with a dampening of the quadratic term, for example. In some embodiments, for example, the slope change factor protects somewhat against overfitting. In some embodiments, for instance, the linear term is a good fit, but confidence may be lower that the quadratic term will continue, so the quadratic term may be reduced by the slope change factor. This may concern bias variance tradeoff or deciding whether or not to make a fit constant, linear, quadratic, cubic, or even-more complicated, for example.

Moreover, some embodiments may include acts that may be performed or accomplished prior to act 71 of method 70. Certain embodiments, for example, include an act of (e.g., using the computer) prompting (e.g., the operator) to input certain information, for example, described herein. Further, in a number of embodiments, various different parameters of the industrial system may be measured, for example, using various sensors, transducers, or the like, for example, that are known in the art. Further, transmitting the (e.g., multiple) different parameters of the industrial system (e.g., to the computer) for displaying to the operator of the system (e.g., in act 71) may be accomplished, in different embodiments, with hard wiring, through wireless communication, or both. In some embodiments, different sensors, transducers, etc., may include dedicated wiring, while in other embodiments, multiplexing may be used. In some embodiments, a computer network may be used. Still further, in some embodiments, (e.g., measured) parameter values are read by the computer, for instance, for displaying (e.g., to the operator of the system, for instance, in act 71) the multiple different parameters of the industrial system. In some embodiments, the method includes accessing (e.g., with the computer) the multiple different parameters of the industrial system or (e.g., measured) parameter values, as examples (e.g., in act 71). In some embodiments, for instance, (e.g., measured) parameter values are accessed by the computer, for instance, for displaying (e.g., to the operator of the system). Parameters or parameter values may be accessed or read, for example, from various sensors or equipment that measures or transits the parameters or parameter values (e.g., pressure flow rate, temperature, etc.) of the industrial system (e.g., in act 71).

Furthermore, a number of embodiments include an act (e.g., act 78) of correcting the (e.g., industrial) system, for example, correcting abnormal or potentially-abnormal behavior of the industrial system. In some embodiments, for example, an act (e.g., act 78) of correcting potentially-abnormal behavior of the industrial system includes adjusting at least one flow rate in the industrial system, adjusting at least one level (e.g., a liquid level in a tank) in the industrial system, adjusting at least one pressure in the industrial system, adjusting a control scheme in the industrial system, or a combination thereof, as examples. Further, in various embodiments, the multiple different parameters include at least ten, at least twenty, at least thirty, at least forty, or at least fifty different parameters, as examples (e.g., displayed in act 71). In some embodiments, an act (e.g., act 78) of correcting the potentially-abnormal behavior of the industrial system may be done using the computer, but in other embodiments, certain corrective action may be performed by the operator, for example, without using the computer specifically to implement the corrective action. In different embodiments, or for different corrective actions, corrective actions (e.g., of act 78) can be computer implemented or otherwise.

Other embodiments include an apparatus and/or various methods of obtaining or providing an apparatus or information, for instance, that include a novel combination of the features described herein. Even further embodiments include at least one means for accomplishing at least one functional aspect described herein. The subject matter described herein includes various means for accomplishing the various functions or acts described herein or that are apparent from the structure and acts described. Each function described herein is also contemplated as a means for accomplishing that function, or where appropriate, as a step for accomplishing that function. Moreover, various embodiments include certain (e.g., combinations of) aspects described herein. All novel combinations are potential embodiments. Some embodiments may include a subset of elements described herein and various embodiments include additional elements as well. Further, various embodiments of the subject matter described herein include various combinations of the acts, structure, components, and features described herein, shown in the drawings, described in any documents that are incorporated by reference herein, or that are known in the art. Moreover, certain procedures can include acts such as manufacturing, obtaining, or providing components that perform functions described herein or in the documents that are incorporated by reference. Further, as used herein, the word “or”, except where indicated otherwise, does not imply that the alternatives listed are mutually exclusive. Even further, where alternatives are listed herein, it should be understood that in some embodiments, fewer alternatives may be available, or in particular embodiments, just one alternative may be available, as examples.

What is claimed is:

1. A computerized method of communicating potentially abnormal behavior of an industrial system to an operator of the industrial system, the method comprising, using a computer:
simultaneously displaying to the operator of the industrial system multiple different measured parameters of the industrial system;
for a particular parameter of the multiple different measured parameters of the industrial system, evaluating whether the particular parameter is projected to go outside of a boundary for the particular parameter within a predetermined future period of time; and
providing a warning to the operator of the industrial system when the particular parameter is projected to go outside of the boundary for the particular parameter within the predetermined future period of time;
wherein, the evaluating whether the particular parameter is projected to go outside of the boundary for the particular parameter within the predetermined future period of time comprises:
dividing a preceding period of time into multiple time periods;
for each time period of the multiple time periods, recalling multiple values of the particular parameter at multiple different times during the time period; and
using the multiple values from each time period of the multiple time periods to calculate whether the particular parameter is projected to go outside of the boundary for the particular parameter within the predetermined future period of time.

2. The method of claim 1 wherein the using the multiple values from each time period of the multiple time periods to calculate whether the particular parameter is projected to go outside of the boundary for the particular parameter within the predetermined future period of time comprises, using the computer:
using the multiple values from each time period of the multiple time periods to calculate a time-period-specific intermediate value for the time period;
combining each time-period-specific intermediate value for each time period of the multiple time periods to obtain a combined intermediate value; and
using the combined intermediate value to determine whether the particular parameter is projected to go outside of the boundary for the particular parameter within the predetermined future period of time.

3. The method of claim 2 wherein each time-period-specific intermediate value for each time period of the multiple time periods comprises a slope of the particular parameter within the time period.

4. The method of claim 2 wherein the combined intermediate value is a projected slope of the particular parameter with respect to time.

5. The method of claim 2 wherein:
the combining each time-period-specific intermediate value comprises, using the computer, subtracting a first time-period-specific intermediate value for a first time period of the multiple time periods from a second time-period-specific intermediate value for a second time period of the multiple time periods;
the second time period is more recent than the first time period; and
the second time period and the first time period are consecutive.

6. The method of claim 2 wherein the combining each time-period-specific intermediate value comprises, using the computer:
calculating a difference between a first time-period-specific intermediate value for a first time period of the multiple time periods and a second time-period-specific intermediate value for a second time period of the multiple time periods, and
adding the difference to the second time-period-specific intermediate value.

7. The method of claim 2 wherein the combining each time-period-specific intermediate value comprises, using the computer:
multiplying by a slope change factor that has an absolute value that is less than one; or
dividing by a slope change factor that has an absolute value that is greater than one.

8. The method of claim 2 wherein the combining each time-period-specific intermediate value comprises, using the computer, weighting more heavily a more-recent time-period-specific intermediate value for a more-recent time period of the multiple time periods.

9. The method of claim 1 wherein:
the evaluating whether the particular parameter is projected to go outside of the boundary for the particular parameter within the predetermined future period of time comprises, using the computer:
calculating a first slope difference between a first slope for a first time period of the multiple time periods and a second slope for a second time period of the multiple time periods; and
calculating a second slope difference between the second slope for the second time period of the multiple time periods and a third slope for a third time period of the multiple time periods;
the second time period is more recent than the first time period;
the third time period is more recent than the second time period;
the first time period, the second time period, and the third time period are consecutive; and
the first slope difference and the second slope difference are used to calculate a projected slope of the particular parameter with respect to time.

10. The method of claim 9 further comprising:
averaging the first slope difference and the second slope difference to obtain an average slope difference; and
subtracting the average slope difference from the third slope to obtain a projected slope.

11. The method of claim 10 further comprising, using the computer: multiplying or dividing the average slope difference by a slope change factor before subtracting the average slope difference from the third slope to obtain the projected slope.

12. The method of claim 1 wherein the evaluating whether the particular parameter is projected to go outside of the boundary for the particular parameter within the predetermined future period of time comprises:
calculating a first slope difference between a first slope for a first time period of the multiple time periods and a second slope for a second time period of the multiple time periods;
calculating a second slope difference between the second slope for the second time period of the multiple time periods and a third slope for a third time period of the multiple time periods; and
calculating a third slope difference between the third slope for the third time period of the multiple time periods and a fourth slope for a fourth time period of the multiple time periods.

13. The method of claim 1 wherein:
providing the warning to the operator comprises, using the computer, providing a visual display to the operator;
the visual display is displayed in a first manner when the particular parameter is already outside of the boundary for the particular parameter; and
the visual display is displayed in a second manner when the particular parameter is projected to go outside of the boundary for the particular parameter within the predetermined future period of time.

14. The method of claim 13 wherein the visual display to the operator comprises an arrow.

15. The method of claim 14 wherein:
the arrow is displayed next to a numerical display of the particular parameter; and
the warning to the operator comprises, using the computer, providing an audible indication to the operator.

16. The method of claim 14 wherein:
the arrow is displayed solid when the particular parameter is already outside of the boundary for the particular parameter; and
the arrow is displayed hollow when the particular parameter is projected to go outside of the boundary for the particular parameter within the predetermined future period of time.

17. The method of claim 1 wherein the evaluating whether the particular parameter is projected to go outside of the boundary for the particular parameter within the predetermined future period of time comprises calculating a coefficient of determination for the particular parameter.

18. The method of claim 17 further comprising using the coefficient of determination to select which process to use for the evaluating whether the particular parameter is projected to go outside of the boundary for the particular parameter within the predetermined future period of time.

19. The method of claim 1 wherein the using the multiple values from each time period of the multiple time periods to calculate whether the particular parameter is projected to go outside of the boundary for the particular parameter within the predetermined future period of time comprises using linear regression to determine whether the particular parameter is projected to go outside of the boundary for the particular parameter within the predetermined future period of time.

20. The method of claim 1 wherein the using the multiple values from each time period of the multiple time periods to calculate whether the particular parameter is projected to go outside of the boundary for the particular parameter within the predetermined future period of time comprises using a first order lag function to determine whether the particular parameter is projected to go outside of the boundary for the particular parameter within the predetermined future period of time.
